(19) United States
(12) Patent Application Publication
(10) Pub. No.: US 2010/0186563 A1
(43) Pub. Date: Jul. 29, 2010

(54) Adjustable apparatus for measuring strand materials of indefinite length with cutting guide to facilitate and enable the cutting of numerous identical-length pieces of strand material. Also called "The Short Cut"

(76) Inventor: Shelly Dawn Lee, Portland, OR (US)

Correspondence Address: Shelly Lee, P.O. Box 3014, Tualatin, OR, 97062, US

(21) Appl. No.: 12/322,031

(22) Filed: Jan. 26, 2009

(51) Int. Cl. B26D 7/02; B26D 3/00

(52) U.S. Cl. 83/50; 83/453

(57) ABSTRACT

My invention relates broadly to devices for knitting, crocheting and other crafting used to advantage for making numerous forms of fringe and other adornment requiring the use of multiple, identical-length strand materials and has as one of its objectives to provide a simply constructed, reusable, adjustable device. A further objective of this invention is to provide a measuring and cutting device of the character set forth, that is simple in construction, inexpensive to manufacture, and is extremely efficient and versatile in use and service. It has been common practice to use a piece of cardboard for one of its uses, making fringe, however, only one size of fringe or other strand material can be manufactured by that method, making it necessary to have a separate apparatus for each length of strand material desired. It is to overcome this problem that I have primarily created this adjustable apparatus which consists in the construction and combination of parts, which will be more fully hereinafter described, and pointed out in the claims.

The object of my invention is to provide a simple and inexpensive device for facilitating the manufacture of fringe and other adornments of like nature in multiple sizes. From the foregoing abstract description, taken in connection with the more detailed description and accompanying drawings, it is thought that the construction and operation of the device will be readily understood without requiring a more extended explanation, and that the numerous advantages of such devise will be apparent.

### CROSS-REFERENCE TO RELATED APPLICATIONS

| | U.S. Pat. No. | Date MM-YYYY | Name | Classification |
|---|---|---|---|---|
| A | US-2,803,051 | August 1957 | Dorothea Gutzmann | 66/1A |
| B | US-2,655,017 | October 1953 | Scott Bessie L | 66/1A |
| C | US-2,099,600 | November 1937 | Denner Charlotte I | 66/1A |
| D | US-1,691,527 | November 1928 | Hideichi Sakurai; et. al | 66/1A |
| E | US-1,532,810 | April 1925 | Gourley Edla M. | 66/1A |
| F | US-1,317,367 | September 1919 | Hansen | 66/1A |
| G | US-1,168,554 | January 1916 | Riley | 66/1R |
| H | US-369,075 | August 1887 | Post | 66/1A |
| I | US-4,109,355 | August 1978 | Davitian, Edward | 28/151 |
| J | US-3,234,759 | February 1966 | Therese Larrasoain Marie | 66/1A |
| K | US-3,739,437 | June 1973 | Alberici et.al. | 28/151 |
| L | US-1,975,924 | October 1934 | Collingbourne Albert B | 28/151 |
| M | US-4,072,173 | February 1978 | Markowitz et. Al. | 139/34 |
| N | application Ser. No. | | Lozar, Linda Margret | |
| | 11/299,551 | | | |

The above-listed patents are of similar subject matter, but this application does not refer to them nor copend on them. The final entry, a patent application by Linda Lozar was for a similar device; however it was more rudimentary and not adjustable.

### STATEMENT REGARDING FEDERALLY SPONSORED RESEARCH OR DEVELOPMENT

This invention was not made under any federally sponsored research and development.

### BACKGROUND OF THE INVENTION

This invention relates in general to equipment and methods for producing artistic designs which are embodied with a wide range of practical items and provides especially for the use of strand material of indefinite length such as cord, thread, wire or other material used in any crafting that requires the use of identical-length pieces of said strand material. Included in this description is fringe-making for crocheting, knitting or other fabric craft, and various types of wire or metal used in jewelry-making and other metal crafts. Potential use for other strand materials such as acrylic thread for fly-fish lures, wire or ribbon loopings, lacings and weavings and the like which are more or less part of the material structure of the article with which such designs are associated and other crafts are included in the utility of this invention, its utility would apply to any flexible material, conceivably of any size as the invention can be made at any scale required, that needs to be cut into identical-length pieces.

### BRIEF SUMMARY OF THE INVENTION

My invention relates broadly to devices which facilitate the measurement and cutting of strand materials for use in knitting, crocheting and other crafting and used to advantage for making numerous forms of fringe and other adornment requiring the use of multiple, identical-length strand materials. It has been common practice to either hand measure the multiple strands and cut them individually, which is prohibitively time consuming, tedious and imprecise, or to use a piece of cardboard, however, only one size of fringe or other strand material can be manufactured by that method, making it necessary to have a separate apparatus for each length of strand material desired. It is to overcome these problems that I have primarily created this adjustable apparatus hereinafter more fully described and claimed and shown in the drawings.

By making an adjustable, sturdy apparatus, the crafter can use it countless times to create various projects which require strand materials at either identical or even differing lengths. The cutting guides on the apparatus assure a clean, equal cut with less potential for injury than cutting along a piece of cardboard or other make-shift apparatus. The object of this invention, generally, is to provide a simple, efficient, reusable, adjustable and inexpensive device for facilitating the manufacture of fringe and other adornment of like nature as well as strand pieces for use in other crafts. With these and other objects in view, the invention consists of certain novel features of construction as hereinafter shown and described and then specifically pointed out in the claims, and in drawings illustrative of the preferred embodiment of the invention. I achieve these objectives by the device illustrated in the accompanying drawings, wherein like numbers of reference indicate corresponding parts in several views.

### BRIEF DESCRIPTION OF THE SEVERAL VIEWS OF THE DRAWING

FIG. 1 is a side view of the present invention, showing the apparatus with the tension band and giving a clear view of the bars and tubes, including the adjustment holes and adjustment pin.

FIG. 2 is a top view of the present invention, showing the cutting guide and opposing anchor pins, though this view does not have the tension band illustrated.

FIG. 3 is an elevated side or perspective view of the present invention which allows the ability to see both cutting guides and sets of anchor pins, again the tension band is not illustrated, to allow for a clear view of the adjustment bars and tubes.

FIGS. 4-8 are sequential views of the steps used in utilizing the present invention to measure and cut identical-length strands of material with the final illustrations detailing how the tension band aids the function of the invention for the final steps of the measuring and cutting process.

### DETAILED DESCRIPTION OF THE INVENTION

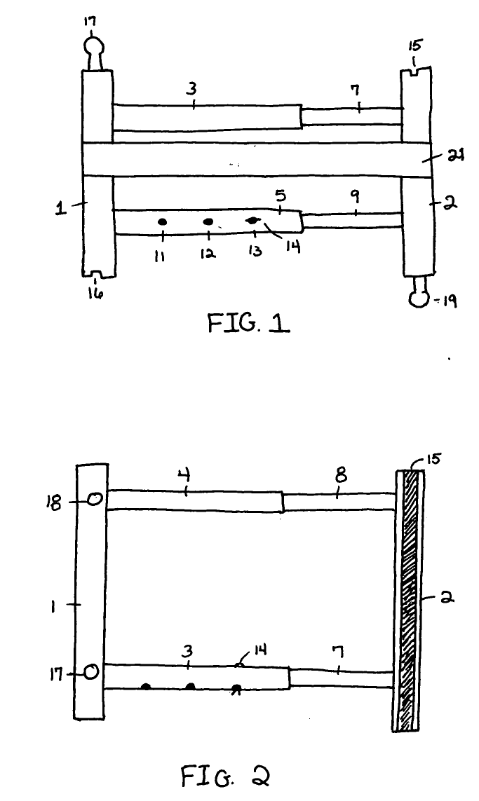

I hereby claim priority to my earlier filed provisional filing 61/062,800 filed on Jan. 28, 2008. I declare the following to be a full, clear, and exact description of the invention, such as will enable others skilled in the art to which it appertains to make and use the same. This apparatus was invented to include certain new and useful improvements to devices currently in use for this purpose. The apparatus is illustrated in the accompanying drawings, wherein like numbers of reference indicate corresponding parts in several views. Referring to the drawings of the preferred embodiment in greater detail, FIG. 1 shows a side view of the apparatus. “The Short Cut” consists of two same size, rectangular flat plates (labeled 1 and 2) separated by four equal-length tubes (labeled 3-6) paired with four equal length bars small enough to fit within the tubes (labeled 7-10). The two plates are made of material that will be sturdy enough not to gouge or warp when the chosen strand material is wrapped around the apparatus. For thread or yarn, wooden or even sturdy plastic plates can be used. For wire or metal, the plates would need to be either hard wood or even metal to prevent wear and warping. The tubes and bars can be made of metal or other material, depending on the desire of the creator. However, the bars and tubes must be made of material rigid enough to hold the plates firmly apart and be appropriate for drilling holes for adjustment. The tubes and bars are equal in length and hold the two plates apart and provide the adjustability for the invention. One of the tubes (labeled 5) has been drilled with holes and its matching bar (labeled 9) also has a hole. When the desired measurement is reached, an adjustment pin (labeled 14) is inserted through both the hole in the bar and the desired hole in the tube to lock the apparatus at that hole. For the desired embodiment, I have utilized a simple metal adjustment pin. However, there are numerous other possibilities that would not detract from the utility of my design. Once the appropriate measurement hole (labeled 11-13) has been selected (the holes will be measured so that each additional hole creates an additional, equal length in the strand lengths produced), strand material is then wound around the circumference of The Short Cut. The tension band is placed around the outer edge of the apparatus, perpendicular to the strand material on the plates. I have utilized a simple rubber band, but any banding material that would maintain the tension on the strand material while it is being cut could be substituted, again without departing from the scope of the invention design. The strand material is then severed using the cutting guides to produce the desired identical-length strands. While I have utilized four tubes and bars to construct my invention, it can be constructed using as few as two tubes and bars or many more, depending on the desired construction and without departing from the scope of the invention. In addition, depending on the size of the apparatus and its bars and tubes, it can have more holes than the three provided in this rendering.

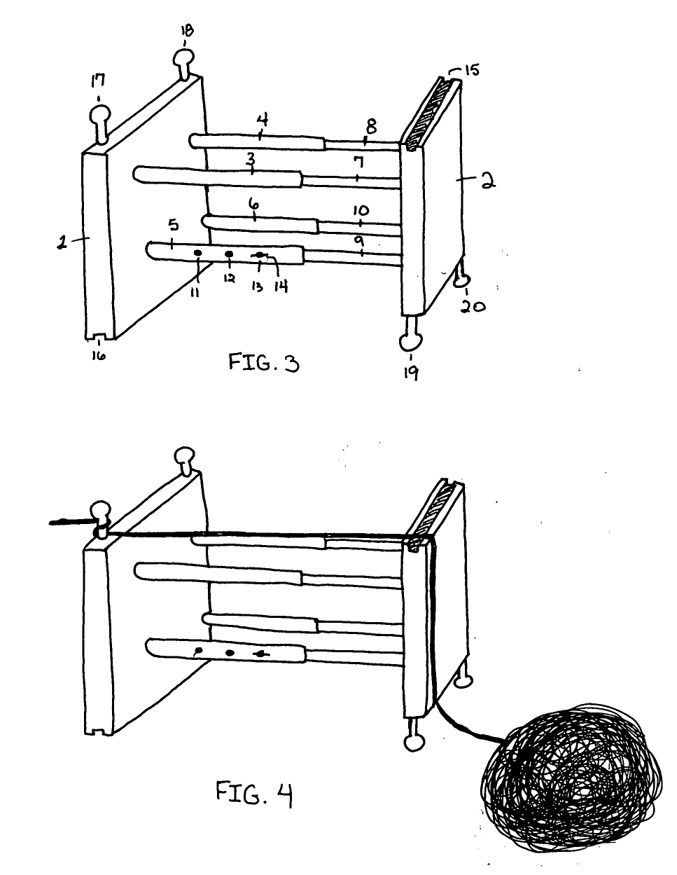

As shown in FIG. 1, each plate has anchor pins (labeled 17-20) on one side and a cutting guide on the opposite side (labeled 15 and 16). The anchor pins must be long enough to allow the desired thread material to be firmly anchored before winding around the apparatus and to provide a firm block to the strands as they are being wound so the strands do not shift while other strands are wound or while being cut. The cutting guides must be sufficiently deep to allow for the strand material to stretch taut across the guide and for safe cutting, not allowing the cutting tool to divert to either side of the guide and preventing potential injury to the invention user. The two plates are juxtaposed so that one side has the pins facing up, while the other plate has the pins facing down. This makes the cutting guides equidistant around the invention, thus making it possible to produce identical length strands. Looking at FIG. 2, the top view, it is possible to see the cutting groove and how the anchor pins provide an area to wind the strand material taut.

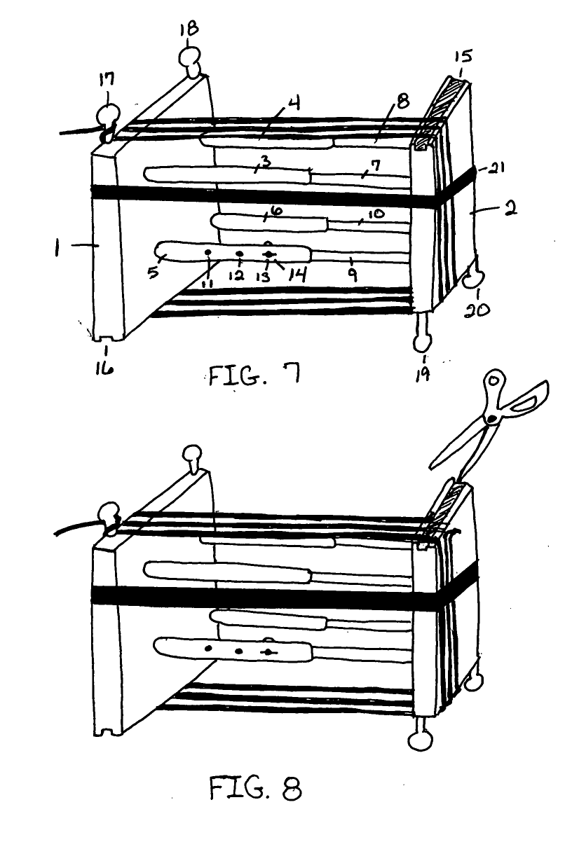

FIGS. 4-8 show the sequential process of wrapping the loose end of the strand material around one of the anchor pins (labeled 17) to maintain tension on the strand material. Then the strand material is run around the circumference of The Short Cut, first between the anchoring pins (labeled 17 and 18), then taut across the cutting guide (labeled 15) of the opposite plate (labeled 2), down the back side, between the bottom anchor pins (labeled 19 and 20), across the bottom cutting guide (labeled 16) and continuing around as many times as needed to produce the amount of strand material pieces desired, the first strand being flush against the anchor pins and each succeeding strand flush with the previous strand. In the figures I have illustrated the strands as being separated from each other. In actual use, such separation would not be necessary. The strands can be beside each other or even layered with negligible difference in strand length. Once the amount of material desired is on The Short Cut, the tension band (labeled 21) is placed around the sides perpendicular to the strand material. See FIG. 7 This will maintain the position and tension on the strands as they are cut. First the top cutting guide (labeled 15) is used, then the apparatus is turned over and the second cutting guide (labeled 16) is used. Once both cuts have been made, numerous identical-length strands of material will have been made, though the end of the strand material that was anchored on the anchoring pin will be longer than the other strands created.

From the foregoing description, taken in connection with the accompanying drawings, it is thought that the construction and operation of the device will be readily understood without requiring a more extended explanation, and that the numerous advantages of such a devise will be apparent.

What I claim as my invention is:

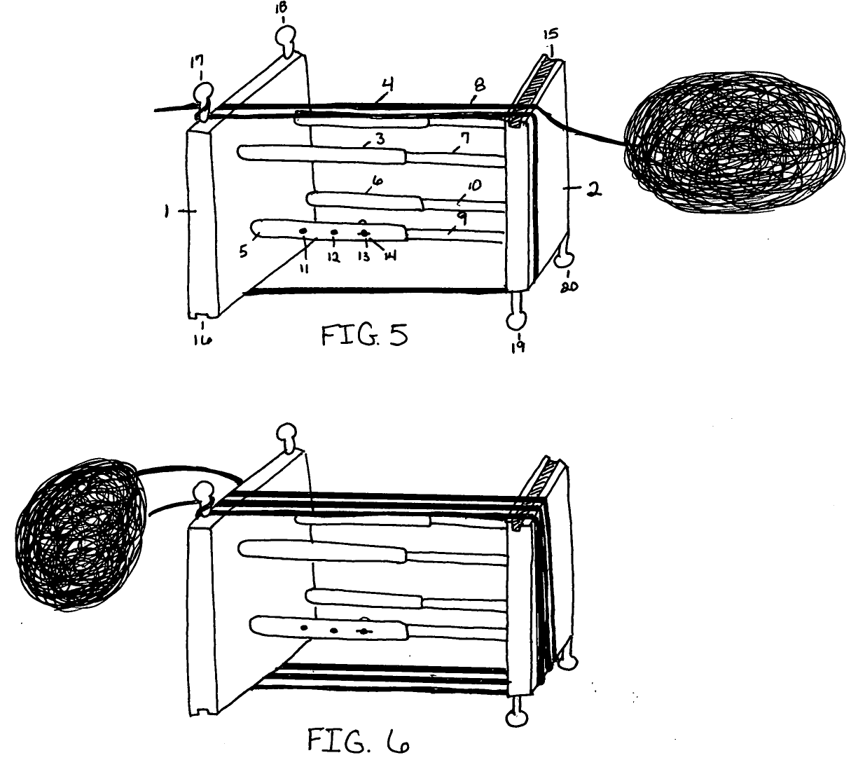

1. A crafting device, used for measuring and cutting identical-length strand material comprised of:
a combination of two equal sized wood, rigid plastic or metal plates (or any relatively rigid material) cut rectangular in shape having ends, sides, a top surface and a bottom surface (labeled 1 and 2)
said plates each having a cutting edge deep enough to allow ease of cutting and for material to stretch taut across on one of the short sides of the rectangle (labeled 15 and 16) and two anchor pins long enough to anchor the desired strand material to be cut on the opposite short side of the rectangle of the same plate (labeled 17-20)
said plates have their anchor pins facing the polar opposite direction from the other plate, where one plate has the anchor pins facing up, the other's anchor pins are facing down—where the first plate has its anchor pins are facing up and has its cutting guide facing down and vice versa for the second plate as illustrated in FIGS. 1-8
said plates being spaced apart by permanently attached, identical-length bars (labeled 7-10) and tubes (labeled 3-6) which hold said plates apart the desired distance to create the required measurement of strand material
one set of said bars and tubes (labeled 5 and 9) being drilled with holes of equal intervals (labeled 11-13), a wire pin to be placed in the holes (labeled 14), for the purposes of adjusting the device, substantially as described
once a measurement is chosen, a rubber band of sturdy flexibility or other holding means (labeled 21) is wrapped around the device to maintain tension for cutting when the desired amount of material is achieved.

2. A method of using the apparatus described in claim 1 for use in measuring and cutting strand material for use in various crafts, said method comprising,
A) the user removing the tension band as claimed in claim 1 from around the device,
B) then the use of the bars and tubes as claimed in claim 1 allow The Short Cut to expand or retract as desired, thereby permitting lateral adjustment of the two plates with respect to each other and a pin-clasp placed in the desired hole as claimed in claim 1 for the desired length keeps the bars stationary in one position, which retains the same parallel position for all bars,
C) once the user determines the desired length of the strand pieces and selects the appropriate hole on the adjustment tubes and bars as illustrated in FIGS. 1-8
D) the end of the strand material is wrapped securely around one of the longitudinal anchor pins as claimed in claim 1 to preserve tension while the stand material is wrapped around the device
E) the strand material is wrapped around the entire device, falling over the cutting guide opposite to the anchor pin and continuing around the circumference of the device, between the opposing anchor pins and continuing around until again on the side with the original anchor pin
F) the material is pushed flush with the anchor pin and the winding of the material around the circumference of the device continues, while ensuring to keep the tension on the strand material and that each strand is wound next to the prior strand for maximum accuracy, while it is not necessary for each wound length to be precisely next to the prior length, it can result in minute length differences FIGS. 4-8 illustrate this process,
G) once the user has wound the desired amount of strand material, the user places the tension band as claimed in claim 1 around The Short Cut and perpendicular to the wound strands to hold them in place while the material is to be cut,
H) using an appropriate cutting tool for the material being cut (scissors, wire-cutters, etc.), the user then uses the cutting guides (labeled 15 and 16) as claimed in claim 1 to cut first one end, then the other—this results in multiple, identical-length strands of material. See FIGS. 6-8.

3. If desired, my improved apparatus claimed in claim 1 may be constructed with as few as two adjustable bars and tubes or as many as desired
it is readily apparent to those skilled in the arts to which this invention applies that many minor changes in the construction and arrangement of the parts of my device can be made and substituted for those shown and described without departing from the nature and principles of my invention or the scope of the appended claims
I do not desire to be limited to the precise construction shown, as modifications are possible which still come within the scope of the claimed invention without departing from the principle of the invention or sacrificing any of its advantages.
